(19) United States
(12) Patent Application Publication
(10) Pub. No.: US 2025/0184007 A1
(43) Pub. Date: Jun. 5, 2025

(54) MODULATION SYSTEM CONFIGURED TO CONTROL MODULATION OF A SIGNAL

(71) Applicants: L'AIR LIQUIDE SOCIETE ANONYME POUR L'ETUDE ET L'EXPLOITATION DES PROCEDES GEORGES CLAUDE, Paris (FR); ECOLE NATIONALE D'INGÉNIEURS DE BREST (ENIB), Plouzane (FR)

(72) Inventors: Arnaud GARDELEIN, Sassenage (FR); Maeva FRANCO, Sassenage (FR); Ammar SHARAIHA, Brest Cedex 3 (FR); Pascal MOREL, Brest Cedex 3 (FR)

(73) Assignees: L'AIR LIQUIDE SOCIETE ANONYME POUR L'ETUDE ET L'EXPLOITATION DES PROCEDES GEORGES CLAUDE, Paris (FR); Ecole Nationale d'Ingenieurs de Brest (ENIB), Plouzane (FR)

(21) Appl. No.: 18/844,413

(22) PCT Filed: Mar. 7, 2023
(86) PCT No.: PCT/EP2023/055673

§ 371 Date: Sep. 6, 2024

(30) Foreign Application Priority Data
Mar. 11, 2022 (FR) 2202166

(51) Int. Cl. H04B 10/516

(52) U.S. Cl. CPC H04B 10/516

(57) ABSTRACT

Modulation system 10 configured to control modulation of a signal, the system comprising:
an optical modulator configured to receive:
   an input signal formed by a carrier SOE, SOE1, SOE2, and
   a modulation signal SM, SM1, SM2,
a cooling device 12, 12-1, 12-2 configured to cool the optical modulator to a temperature greater than or equal to 10 K, preferably greater than or equal to 40 K, and to cool the optical modulator to a temperature less than or equal to 90 K, preferably less than or equal to 80 K.

### SCOPE OF THE INVENTION

The invention relates to a modulation system configured to control the modulation of an optical input signal.

### STATE OF THE ART

The conversion of information from the electrical domain to the optical domain involves the use of a modulator.

U.S. Pat. No. 10,097,281 B1 describes an optoelectronic data link system involving cryogenic cooling. And U.S. Pat. No. 5,271,074 A discloses an integrated optical wave guide apparatus.

It is known to use modulators allowing amplitude modulation.

An example of amplitude modulation is Pulse Amplitude Modulation (Pam). This modulation is a form of signal modulation in which message information is encoded according to the amplitude of a series of signal pulses. It is an analogue pulse modulation scheme in which the amplitudes of a train of carrier pulses are changed according to the sample value of the message signal.

An alternative type of modulation is quadrature amplitude modulation, this modulation is also called “QAM” (whose acronym stands for “Quadrature Amplitude Modulation”). This modulation is a form of modulation of a carrier by modifying the amplitude of the carrier itself and of a quadrature wave according to the information carried by two input signals. A quadrature is defined by a wave that is 90° out of phase with the carrier.

In other words, QAM modulation can be considered as amplitude modulation of a wave, expressed in complex, by a signal, expressed in complex. The amplitude and phase of the carrier are simultaneously modified according to the information to be transmitted.

These two types of modulation are known to comprise a constellation of 16, 32 or 64 points, as illustrated in FIGS. 1a, 1b and 1c, for the case of quadrature amplitude modulation. QAM constellations with a large number of points can be used to achieve a higher data rate. And QAM constellations with a lower number of points are used to reduce modulation-induced noise and ensure a low bit error rate.

FIGS. 1a, 1b and 1c illustrate a constellation diagram. The constellation diagram is the representation of a signal modulated by a digital modulation such as quadrature amplitude modulation (QAM). The representation is located in a two-dimensional diagram whose axes delimit the complex plane at the symbol sampling instants. The points in the complex plane are the images of the symbols present at this given moment resulting from the modulation. Constellation diagrams can be used to identify the type of interference or distortion in a signal.

Representing a symbol as a complex number makes it possible to extract its real (cosine) and imaginary (sine) parts. A symbol can therefore be transmitted by modulating two carriers of the same frequency with these components. They are then called quadrature carriers. A coherent detector is capable of separately demodulating these components. The principle of independently modulating two carriers forms the basis of quadrature modulation.

The two components of a symbol taken as a complex number can be visualized in a coordinate system with as abscissa the real component (I-axis, or “in-phase”) and as ordinate the imaginary component (Q-axis, or “in quadrature”). Displaying all the symbols at a given time in this coordinate system constitutes the constellation diagram. The points in a constellation diagram are called constellation points.

The constellation diagrams illustrated in FIGS. 1a, 1 and 1c show the different positions of the states in different quadrature amplitude modulation orders (QAM16, QAM32 and QAM 64). The more the order of modulation increases, the more the number of points on the QAM constellation diagram increases.

We can see in these QAM constellation diagrams that the more the modulation order increases, the more the distance between the points of the constellation decreases for a given maximum amplitude. Therefore, small amounts of noise can cause larger problems when the modulation order increases.

The more noise level increases due to the weak signals, the more the area covered by a point in the constellation increases. If it becomes too large, the receiver is unable to determine the position of the transmitted signal on the constellation, resulting in errors. It is also noted that the higher the order of modulation of the QAM signal, the greater the amplitude variation of the transmitted signal if it is desired to maintain a constant distance between the points of the constellation.

The same teachings apply for an amplitude pulse modulation, called Pam modulation. However, Pam constellation diagrams are formed by a plurality of points defined along an axis.

To be able to define the number of points in the constellation, it is important to take into account the linear area and the extinction rate of the amplifier used as a modulator. The extinction rate corresponds to the ratio in dB between the maximum power of the modulated signal with respect to the minimum power of the modulated signal. The extinction rate of the same amplifier at room temperature is of the order of 20 dB.

Linear area defines the range of powers for which the input signal is amplified to a desired gain minus, for example, 1 or 3 dB.

To convert an electrical signal into an optical signal, it is known to use modulators of three types, the Mach-Zehnder modulator (commonly referred to as the MZM modulator), the electro-absorbent modulator (commonly referred to as the EAM modulator) and the use of a solid-state amplifier.

The Mach-Zehnder modulator is an interferometer. An interferometer is an instrument for forming and studying interference fringes. The Mach-Zehnder modulator has an extinction ratio of the order of 25 to 30 dB.

Nevertheless, the Mach-Zehnder modulator has a greatly reduced extinction rate in the quasi-linear area of the modulator. This is caused by the transfer function of this modulator which is sinusoidal in shape. This transfer function is conditioned by the voltage of a modulation signal. For such a modulator, the maximum order of multilevel modulation does not exceed PAM-16, namely a modulation on 16 distinct amplitude levels.

The electro-absorbent modulator is an inverted polarized diode. The diode is made from semiconductor materials. The variation of the bias voltage changes the absorption of an incident light wave.

Thus, according to the variation of the bias voltage, an amplitude modulation of an incident optical signal according to an applied reverse voltage is obtained.

However, such a device has a transfer function that has a non-linearity limiting the extinction rate in the linear portion to only 15 dB.

The voltage range over which the electro-absorbent modulator is driven is much lower than the Mach-Zehnder modulator. For the electro-absorbent modulator, the maximum order of multilevel modulation does not exceed PAM-4, namely a modulation on 4 distinct amplitude levels.

An amplifier is an electronic or optoelectronic system that amplifies an electrical or optical signal. The energy required for amplification is drawn from the power supply of the system. A perfect amplifier does not distort the input signal: its output is an exact replica of the input with increased power.

Amplifiers are used in almost all circuits in electronics and optics: they can raise the voltage of an electrical signal or the power of an optical signal to a level usable by the rest of the system, increase the output current of a sensor to allow transmission without interference, provide sufficient maximum power to power a load such as a radio antenna or an electro acoustic enclosure.

An amplifier amplifies a signal to a certain bandwidth. In the case of an electrical circuit, the bandwidth defines a range of frequencies in which the signal can be amplified. In the case of an optical circuit, the passband defines a range of frequencies or wavelengths in which the signal can be amplified, frequency and wavelength being related by the equation f=c/λ, with f defining the frequency of the light wave (defined in Hz), c defining the velocity (defined in m·s−1) and λ defining the wavelength of the light wave (defined in m).

Optical amplification is obtained in forward polarization. An amplitude modulation of an incident optical signal may be obtained by varying the bias current. The variation of the bias current changes the gain of the solid-state optical amplifier.

The extinction rate of the solid-state optical amplifier is typically in the range of 10 to 15 dB. For a solid-state optical amplifier or a reflective solid-state optical amplifier, the maximum order of multilevel modulation does not exceed PAM-4, namely a modulation on 4 distinct amplitude levels.

There is therefore a need to be able to increase the linear area on which the signal can be modulated and the number of constellation points.

The aim of the invention is to provide a system to meet these needs.

### BRIEF DESCRIPTION OF THE INVENTION

To this end, the present invention relates to a modulation system configured to control the modulation of a signal, the system comprising:
an optical modulator configured to receive:
   an input signal formed by a carrier, and
   a modulation signal,
a cooling device configured to cool the optical modulator to a temperature greater than or equal to 10K, preferably greater than or equal to 40K, and to cool the optical modulator to a temperature less than or equal to 90K, preferably greater than or equal to 80K.

Advantageously, at such a cryogenic temperature, the extinction rate of the optical modulator is of the order of 50 dB for a current of 100 mA. This advantageously makes it possible to increase the gain in the linear area of the optical modulator by about 15 dB.

Advantageously, by placing the optical modulator at such a cryogenic temperature, the maximum order of multilevel modulation can reach for example PAM-32, namely a modulation on 32 distinct amplitude levels. And the number of points in the constellation can reach at least 256 points in quadrature amplitude modulation, as part of an electro-optical modulation.

Advantageously, by placing the optical modulator at such a cryogenic temperature, noise at the level of the input signal and the modulation signal can be reduced.

Advantageously, by placing the optical modulator at such a cryogenic temperature, the linearity range of the modulator is increased compared to prior art modulation systems. This allows modulation of input signals whose envelope amplitude is not constant, as in orthogonal frequency division multiplexing (commonly called OFDM: “Orthogonal Frequency-Division Multiplexing”).

OFDM is a method for coding digital signals by orthogonal frequency division in the form of a plurality of subcarriers.

This technique makes it possible to combat frequency selective channels by allowing an equalization of low complexity. These channels manifest themselves in particular in the presence of multiple paths and are all the more penalizing the higher the transmission rate.

Advantageously, the modulation system may also comprise one or more of the following features, considered individually or in any technically possible combination:
the optical modulator is a laser modulator; and/or
the optical modulator is a modulator configured to receive a laser signal; and/or
the laser modulator is a laser diode; and/or
the optical modulator is a modulator configured to receive a laser signal is a laser diode; and/or
the optical modulator is a semiconductor optical amplifier or a reflective semiconductor optical amplifier; and/or
the modulation signal is an electrical signal; and/or
the modulation signal is an optical signal; and/or
the semiconductor optical amplifier is a bidirectional component configured to receive a first-input optical signal at one terminal and a second input optical signal, identical to the first input optical signal, at another terminal in opposite directions; and/or
the input optical signal has a power greater than or equal to −30 dBm and less than or equal to +10 dBm; and/or
the cooling device is active; and/or
the cooling device is passive; and/or
the cooling device is direct; and/or
the cooling device is indirect; and/or
the cooling device comprises a temperature regulator, the temperature regulator being configured to maintain the semiconductor optical amplifier at a target temperature with a margin of a margin less than or equal to 500 mK, preferably less than or equal to 200 mK, and greater than or equal to −500 mK, preferably greater than or equal to −200 mK; and/or
the semiconductor optical amplifier is mounted on an integrated component; and/or
the integrated component is a photonic integrated component; and/or
the modulation system comprises a plurality of semiconductor optical amplifiers or a plurality of reflective semiconductor optical amplifiers; and/or
the cooling device comprises a device for regulating the temperature of at least two semiconductor optical amplifiers; and/or
at least two semiconductor optical amplifiers are at a different temperature; and/or
the modulation signal is a shared modulation signal for each of the semiconductor optical amplifiers; and/or
the modulation signal has a bandwidth greater than or equal to 0.01 GHz and less than or equal to 100 GHz, preferably less than or equal to 40 GHz; and/or
the modulating optical signal and the input optical signal have different polarizations; and/or
the wavelength of the input optical signal differs from the wavelength of the modulation optical signal by at least 0.05 nm, preferably by at least 0.1 nm, preferably by at least 0.5 nm, preferably by at least 1 nm, preferably by at least 1.5 nm and even more preferably by at least 5 nm; and/or
the cooling device comprises:
   a bar made of a material having a thermal conductivity greater than or equal to 20 watts per metre kelvin on which the amplifiers are arranged,
   a cold spot disposed at a first location of the bar, and
   a temperature control device comprising a temperature sensor disposed at a second location of the bar.

A modulation system configured to control modulation of a signal, the system comprising:
an optical modulator configured to receive:
   an input signal formed by a carrier, and
   a modulation signal,
a cooling device configured to one-cool the optical modulator to a cryogenic temperature.

### BRIEF DESCRIPTION OF THE FIGURES

The invention will be better understood in the light of the following description which is given only as an indication and which is not intended to limit said invention, accompanied by the figures below:

FIG. 1a is a representation of a constellation diagram of a quadrature amplitude modulation,

FIG. 1b is a representation of a constellation diagram of a quadrature amplitude modulation,

FIG. 1c is a representation of a constellation diagram of a quadrature amplitude modulation,

FIG. 2 is a schematic representation of an interrupt system according to the invention, according to a first embodiment,

FIG. 3 is a schematic representation of an interrupt system according to the invention, according to a second embodiment,

FIG. 4 is a schematic representation of an interrupt system according to the invention, according to a third embodiment,

FIG. 5 is a schematic representation of an interrupt system according to the invention, according to a fourth embodiment,

FIG. 6 is a schematic representation of an interrupt system according to the invention, according to a fifth embodiment,

FIG. 7 is a schematic representation of an interrupt system according to the invention, according to a sixth embodiment,

FIG. 8 is a schematic representation of an interrupt system according to the invention, according to a seventh embodiment,

FIG. 9 is a schematic representation of an interrupt system according to the invention, according to an eighth embodiment, and

FIG. 10 is a schematic representation of an interrupt system according to the invention, according to a ninth embodiment.

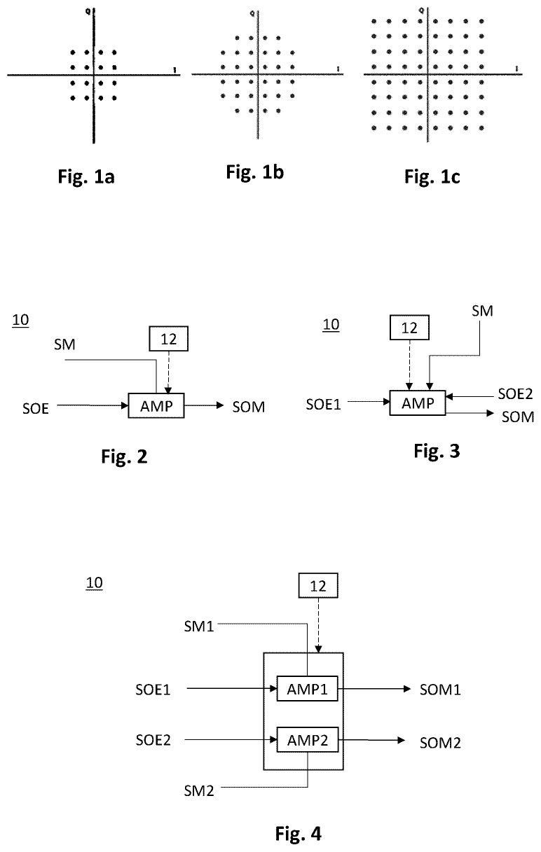

### DETAILED DESCRIPTION OF THE INVENTION

A modulation system configured to control modulation of a signal, the system comprising:
an optical modulator configured to receive:
   an input signal formed by a carrier, and
   a modulation signal,
a cooling device configured to cool the optical modulator to a temperature greater than or equal to 10 K, preferably greater than or equal to 40 K, and less than or equal to 90 K, preferably less than or equal to 80 K.

The optical modulator is configured to receive an input optical signal comprising a carrier whose amplitude may vary.

The optical modulator can be a laser modulator, such as a laser diode, in the case of direct modulation.

In an alternative embodiment, the optical modulator is a semiconductor amplifier or a reflective semiconductor amplifier, in the case of indirect modulation.

The modulation signal has a bandwidth greater than or equal to 0.01 GHz and less than or equal to 100 GHz, preferably less than or equal to 40 GHz. The temperature of the optical modulator conditions the wavelength range at which the signal is modulated.

FIG. 2 illustrates a modulation system 10 configured to control modulation of a signal, the system comprising:
an optical modulator, formed by an amp semiconductor amplifier, configured to receive:
   an input optical signal SOE formed by a carrier, and
   an SM modulation signal,
a cooling device 12 configured to cool the optical modulator to a temperature greater than or equal to 10 K, preferably greater than or equal to 40 K, and less than or equal to 90 K, preferably less than or equal to 80 K.

The signal produced at the output of the optical modulator is a modulated optical signal.

The modulation signal SM can be an electrical signal. Alternatively, the modulation signal is an optical signal. The modulation signal SM provides the modulator with the information necessary for the modification of the carrier of the input optical signal SOE.

Advantageously, the modulation electrical signal SM can be used to provide the power supply to a modulator in the form of a solid-state optical amplifier amp.

It was surprisingly noted that the amp semiconductor optical amplifier provided a non-zero gain when the latter was subjected to a cryogenic temperature, greater than or equal to 10 K, preferably greater than or equal to 40 K and less than or equal to 90 K, preferably less than or equal to 80 K, and that a low power supply, of the order of a few milliamperes was provided.

Since the amp semiconductor optical amplifier consumes little energy at this temperature, it is then possible to replace its power supply via an electrical SM modulation signal with an optical SM modulation signal, for example in the case of QAM16 quadrature modulation.

Advantageously, when the modulation signal is optical, this allows the latter to be offset.

In the case of an optical SM modulation signal, the range of wavelengths over which an input signal may be modulated and the modulation options may be different from the wavelength ranges and modulation options allowed by a modulation signal in electrical form.

In an all-optical modulation system, where the input signal and the modulation signal are optical, the power of the input optical signal SOE is at least 5 dB lower than the power of the modulation signal SM, preferably at least 10 dB lower.

The power of the input optical signal SOE is less than the power of the modulation signal so that the solid-state optical amplifier amp distinguishes the modulation signal SM from the input optical signal SOE.

The modulation signal of a solid-state amplifier amp is the signal having the highest power among the input optical signal SOE and the modulation signal SM.

In one embodiment, the power of the input optical signal is greater than or equal to −30 dBm, preferably greater than or equal to −10 dBm and less than or equal to +10 dBm, preferably less than or equal to +5 dBm. The dBm is a unit that expresses a power in decibels (dB) with respect to a reference value of 1 milliwatt (mW).

The modulation signal SM may have a polarization different from that of the input optical signal SOE. For example, the modulation signal SM is in electric transverse mode, respectively in magnetic transverse mode and the input optical signal SOE is in magnetic transverse mode, respectively in electric transverse mode.

For the remainder of the description, the optical modulator is considered in the form of a semiconductor amplifier amp. FIGS. 2 to 10 cover a modulation system according to the invention comprising a semiconductor amplifier amp.

In the case where the modulation signal is optical, the input optical signal and the optical modulation signal can be provided jointly using a single optical fibre to the optical modulator, for example at one of the terminals of the solid-state amplifier amp.

The amp solid-state optical amplifier is a bidirectional optoelectronic component.

In one embodiment, shown in FIG. 3, a first-input optical signal SOE1 and a second input optical signal SOE2, identical to the first input optical signal SOE1, are supplied to the semiconductor optical amplifier amp in opposite directions via terminals disposed on either side of the amplifier. The input optical signals SOE1 and SOE2 are considered counter-directional.

To facilitate the understanding of FIG. 3, the second input optical signal SOE2 and the modulated optical signal SOM have been shown separately to define the direction of propagation of these signals. However, the second input optical signal SOE2 and the modulated optical signal SOM are counter-propagating signals at the same optical fibre.

In one embodiment, the modulation signal SM and the input optical signal SOe have a different polarity and/or are transmitted to two opposite terminals of a solid-state optical amplifier amp.

In another embodiment, the wavelength of the modulation signal and the input optical signal SOE may be different. For example, the wavelength of the modulation signal SM and the input optical signal SOe is different by at least 0.05 nm, preferably by at least 0.1 nm, preferably by at least 0.5 nm, preferably by at least 1 nm, preferably by at least 1.5 nm and even more preferably by at least 5 nm.

The cooling device 12 of the modulation system 10 is preferably a cryogenic cooling device.

The cooling device 12 may be indirect. The cooling device is considered indirect in the case where a cooling means does not act directly on the optical modulator but on an element for example thermally conductive on which the optical modulator is arranged. The thermally conductive element, cooled by a cooling means, will in turn, by thermal conduction, cool the optical modulator.

An indirect cooling device 12 may for example be formed by a thermally conductive bar which will be cooled at one of its ends by a cooling means. The bar is configured to receive at least one optical modulator.

Advantageously, an indirect cooling device can make it possible to pool a cooling means for several optical modulators on a thermally conductive bar, for example arranged at different locations.

Alternatively, the cooling device 12 may be direct. The direct cooling device 12 is a device configured to apply a thermal variation directly to the optical modulator. The temperature control is carried out directly at the optical modulator.

A direct cooling device may be formed by a dedicated cooling means for locally cooling the one or more optical modulators, for example the one or more semiconductor optical amplifiers amp 1, amp 2.

Advantageously, it is not necessary to have recourse to a conductive thermal structure on which the optical modulator (s) would be arranged.

Advantageously, the use of a direct cooling device 12 makes it possible to better control the temperature supplied to the at least one optical modulator.

Also, as part of a direct cooling device 12, it is easier and faster to compensate for a variation in an optical modulator. It is not necessary to wait for a conductive element to reach the desired temperature at the location where the optical modulator is arranged.

The cooling device 12 can be a passive cooling device.

For example, a passive cooling device can be a radiator in contact with the optical modulator. The radiator radiates to the outside of the modulation system, such as a device for extracting thermal energy by radiation. A passive cooling device 12 may also be formed by a cooling circuit comprising liquid nitrogen.

A passive cooling device is devoid of an energy input. Advantageously, the power consumption for maintaining the optical modulator (s), for example the semiconductor optical amplifier (s) amp 1, amp 2 at a cryogenic temperature is reduced.

A cooling device 12 may be active. An active cooling device requires an energy input to ensure the cooling of the optical modulator. Despite the need for energy input, the temperature regulation of an optical modulator is faster and more reliable due to the control of the cooling device, by regulating its power supply.

FIG. 4 illustrates a modulation device 10 comprising two semiconductor optical amplifiers amp 1, amp 2 or at least two reflective semiconductor optical amplifiers. Each of the two semiconductor optical amplifiers amp 1, amp 2 receives a respective input optical signal SOE 1, SO 2, each comprising a carrier, and a modulation signal SM 1, SM 2, so as to respectively provide a modulated optical signal SOM 1, SOM 2.

At least one of the semiconductor optical amplifiers amp 1, amp 2 is cooled by the cooling device.

In one embodiment, the two semiconductor optical amplifiers amp 1, amp 2 are cooled by the same cooling device 12 or a respective cooling device.

Advantageously, the cooling device 12 can be shared using the same cooling device for two semiconductor optical amplifiers amp 1, amp 2.

The two semiconductor optical amplifiers amp 1, amp 2 can be maintained at the same temperature, for example when at least two semiconductor optical amplifiers amp 1, amp 2 are mounted in an integrated circuit 22 that is cooled by the cooling device 12.

Alternatively, the two semiconductor optical amplifiers amp 1, amp 2 can be maintained at a different temperature. For example, two solid-state optical amplifiers amp 1, amp 2 are maintained at temperatures having a deviation greater than or equal to 5K, preferably a deviation greater than or equal to 10K.

Advantageously, the amplifiers amp 1, amp 2 will modulate the input optical signals SOE 1, SOE 2 respectively received over different wavelength ranges.

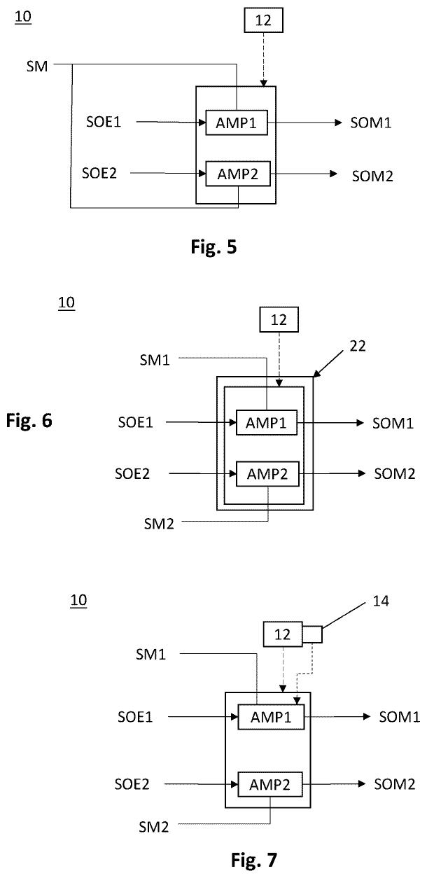

In one embodiment, illustrated in FIG. 5, the same modulation signal SM is pooled for two semiconductor optical amplifiers amp 1, amp 2.

Advantageously, in this way, the modulation of the input optical signals SOE 1, SOE 2 can be ensured simultaneously at the semiconductor optical amplifiers amp 1, amp 2.

In the same way as in the embodiment illustrated in FIG. 5, where the modulation signal SM is shared, the input optical signal can be shared. A single input signal SOE could be split in two and supplied to two solid-state optical amplifiers amp 1, amp 2. Each of the two semiconductor optical amplifiers amp 1, amp 2 receives a different modulation signal SM 1, SM 2, so as to respectively provide a modulated optical signal SOM 1, SOM 2. The modulated optical signals SOM 1, SOM 2 are different

In one embodiment, the input optical signal SOE and the modulation signal SM are respectively shared for at least two amplifiers.

Advantageously, the same modulated signal can be provided at separate locations simultaneously.

In one embodiment, at least one semiconductor optical amplifier amp, amp 1, amp 2 is a discrete component.

Alternatively, a single solid-state optical amplifier amp or a plurality of solid-state optical amplifiers amp 1, amp 2 may form part of an integrated circuit 22, as illustrated in FIG. 6. The integrated circuit 22 is for example a photonic integrated circuit.

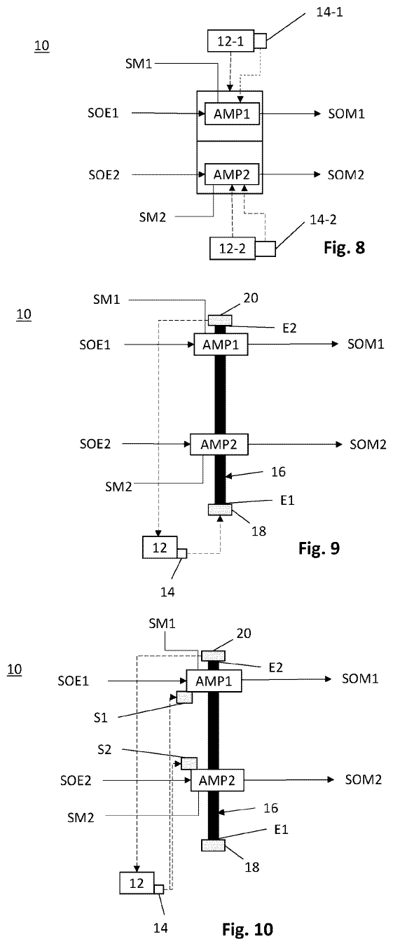

To ensure accurate temperature control of the at least one or each of the semiconductor optical amplifiers amp 1, amp 2 of the modulation system 10, the cooling device 12, 12-1, 12-2 may include a temperature regulator 14, 14-1, 14-2 (shown in FIG. 8).

Preferably, the temperature regulator 14, 14-1, 14-2 is configured to maintain the semiconductor optical amplifier amp, AMP1, AMP2 at a target temperature.

Advantageously, precise control of the temperature of the semiconductor optical amplifier amp, amp 1, amp 2 makes it possible to precisely control over which wavelength range the input signal will be modulated.

Also, the temperature regulator 14, 14-1, 14-2 makes it possible to compensate for the heat supplied by the modulation signal to the semiconductor optical amplifier amp, AMP1, AMP2. The greater the power of the modulation signal SM, SM1, SM2, the greater the heat transmitted this signal. Therefore, to ensure good thermal regulation of the temperature of the optical modulator, for example the semiconductor optical amplifier amp, AMP1, AMP2, it is important to take into account the thermal impact of the modulation signal SM, SM1, SM2.

The temperature controller 14, 14-1, 14-2 may be used to control the temperature of one of the plurality of semiconductor optical amplifiers amp, AMP1, AMP2, as shown in FIG. 7.

Furthermore, the cooling device comprises a temperature regulator, the temperature regulator being configured to maintain the semiconductor optical amplifier at a target temperature with a margin less than or equal to 500 mK, preferably less than or equal to 200 mK, and greater than or equal to −500 mK, preferably greater than or equal to −200 mK.

Advantageously, precise control of the temperature of the semiconductor optical amplifier amp can be ensured. By having precise control of the temperature of the solid-state amplifier amp, it can be controlled over which wavelength range the input optical signal SOE, SOE1, SOE2 will be modulated.

FIG. 8 shows a modulation system according to the invention in which each of the two semiconductor optical amplifiers amp 1, amp 2 comprises a respective cooling device 12-1, 12-2 and a temperature regulator 14-1, 14-2.

Such a system, using cooling devices and respective temperature regulators, makes it possible to better control the temperature of each of the two semiconductor optical amplifiers amp 1, amp 2.

FIG. 9 illustrates an example of the cooling device 14. The cooling device 14 may comprise:
a bar 16 made of a material having a high thermal conductivity on which the N amplifiers are arranged (in the case of FIG. 9, two amplifiers AMP1, and AMP2 are illustrated),
a cold spot 18 disposed at a first location E1 of the bar 16, and
a temperature regulating device 14 comprising a temperature sensor 20 arranged at a second location E2 of the bar.

Preferably, the bar 16 has a thermal conductivity greater than or equal to 20 watts per metre kelvin. The temperature at different locations of the bar 30 is different.

In an embodiment, the bar 16 is made of copper.

The bar can be made of a material having a high thermal conductivity and the presence of a cold spot 18 makes it possible to create a temperature gradient between the first place where the cold source 18 is arranged and one end of the bar 16.

With such a temperature gradient, the positioning of the semiconductor optical amplifiers amp 1, amp 2 is important to be at a desired target temperature T1, T2.

The temperature of the semiconductor optical amplifiers AMP1, AMP2 arranged on rod 16 is conditioned by their location on rod 16.

The cold spot 18 corresponds to a cooling means configured to cool the bar 16 at a particular location on this bar 16 corresponding to the first location E1.

In this way, the amplifiers arranged closest to the cold spot 18 have a colder temperature than the amplifiers furthest from the cold spot 18.

Preferably, the cooling means used is a cryogenic cooler.

The cold spot 18 is preferably positioned at one end of the bar 16 to maximise the temperature gradient between a first end and a second end of the bar 30.

The positioning of a temperature sensor 20 at a second location E2 of the bar 16 makes it possible to determine the temperature of the bar 16 at this second location E2. Since the bar is made of a conductive material, it can be determined, from the measurement of the temperature sensor 34, at least approximately the temperature at each point of the bar and more particularly at the positions where the AMP1, AMP2 semiconductor optical amplifiers are located.

Advantageously, from the temperature measurement at said second location E2 of rod 16, cooling device 12 can determine whether the temperature of semiconductor optical amplifiers AMP1, AMP2 corresponds to the desired target temperature.

If the temperature of at least one semiconductor optical amplifier amp 1, amp 2 is different from the desired target temperature T1, T2, the cooling device 12 controls the regulating device 14 to regulate the temperature of the cold spot 18 of the bar 16.

In another embodiment shown in FIG. 10, the cooling device independently controls the temperature T1, T2 of the AMP1, AMP2 semiconductor optical amplifiers. If one of the semiconductor optical amplifiers amp 1, amp 2 is not at a desired target temperature, the temperature regulator 14 independently regulates the temperature of this amplifier amp 1, amp 2.

Each of the semiconductor optical amplifiers AMP1, AMP2 is associated with a respective additional thermal source S1, S2. Each of the additional heat sources S1, S2 is configured to individually regulate the temperature of one of the semiconductor optical amplifiers amp 1, amp 2.

In one embodiment, the N additional thermal sources are Peltier modules and/or resistors.

Advantageously, the Peltier modules make it possible to regulate the temperatures of the semiconductor optical amplifiers amp 1, amp 2 by locally increasing or decreasing their temperature.

Advantageously, the resistors make it possible to regulate the temperatures of the semiconductor optical amplifiers amp 1, amp 2 by locally increasing their temperature.

The embodiment shown in FIG. 10 is similar to the configuration shown in FIG. 8, but the temperature controller 14 is different. The temperature controller 14 no longer regulates the temperature of the cold point 18 of the rod 16, but directly regulates the temperature of the additional heat sources S1, S2.

The embodiment illustrated in FIG. 10 may be devoid of the bar 16 and the cold spot 18, the heat sources S1 and S2 supplying the cold to the semiconductor amplifiers S1, S2.

The invention has been described above with the aid of embodiments shown in the figures, without limitation of the general inventive concept.

Many other modifications and variations suggest themselves to those skilled in the art, after reflection on the different embodiments illustrated in this application.

These embodiments are given by way of example and are not intended to limit the scope of the invention, which is determined exclusively by the claims below.

In the claims, the word “comprising” does not exclude other elements or steps. The mere fact that different features are listed as mutually dependent claims does not indicate that a combination of these features cannot be advantageously used. Finally, any reference used in the claims shall not be construed as limiting the scope of the invention.

1. Modulation system configured to control modulation of a signal, the system comprising:
an optical modulator configured to receive:
an input signal formed by a carrier, and
a modulation signal,
a cooling device configured to cool the optical modulator to a temperature greater than or equal to 10 K to cool the optical modulator to a temperature less than or equal to 90 K.

2. The modulation system according to claim 1, characterized in that the optical modulator is a semiconductor optical amplifier or a reflective semiconductor optical amplifier.

3. The modulation system according to claim 2, characterized in that the modulation signal is an electrical signal.

4. The modulation system according to claim 1, characterized in that the optical modulator is a modulator configured to receive a laser signal.

5. The modulation system according to claim 4, characterized in that the modulator configured to receive a laser signal is a laser diode.

6. The modulation system according to claim 1, characterized in that the cooling device is direct.

7. The modulation system according to claim 1, characterized in that the cooling device is indirect.

8. The modulation system according to claim 2, characterized in that the cooling device comprises a temperature regulator, the temperature regulator being configured to maintain the semiconductor optical amplifier at a target temperature with a margin of ±500 mK.

9. The modulation system according claim 4, characterized in that the semiconductor optical amplifier is mounted on an integrated component.

10. The modulation system according to claim 9, characterized in that the integrated component is a photonic integrated component.

11. The modulation system according to claim 4, characterized in that the modulation system comprises a plurality of semiconductor optical amplifiers or a plurality of reflective semiconductor optical amplifiers.

12. The modulation system according to claim 11, characterized in that the same cooling device is configured to cool at least two semiconductor optical amplifiers.

13. The modulation system according to claim 1, characterized in that the modulation signal has a bandwidth greater than or equal to 0.01 GHz and less than or equal to 100 GHz.
